(19) United States
(12) Patent Application Publication
(10) Pub. No.: US 2015/0127378 A1
(43) Pub. Date: May 7, 2015

(54) SYSTEMS FOR STORING, PROCESSING AND UTILIZING PROPRIETARY GENETIC INFORMATION

(71) Applicant: YouGene Corp., New York, NY (US)

(72) Inventors: Ryan Downs, Alexandria, VA (US); Ferdinand Los, Rotterdam (NL); Orhan Soykan, Shoreview, MN (US); Roger C. Hahn, Fairfax, VA (US)

(73) Assignee: YouGene Corp., New York, NY (US)

(21) Appl. No.: 14/511,293

(22) Filed: Oct. 10, 2014

Related U.S. Application Data
(63) Continuation-in-part of application No. 13/371,422, filed on Feb. 11, 2012.
Application No. 13/371,422 is a continuation-in-part of application No. 14/452,979, filed on Aug. 6, 2014.
Application No. 14/452,979 is a continuation-in-part of application No. 14/483,921, filed on Sep. 11, 2014.

(51) Int. Cl. G06F 19/00; G06Q 50/18; G06Q 20/40; G06Q 20/14

(52) U.S. Cl. CPC G06F 19/366; G06F 19/322; G06Q 20/14; G06Q 50/184; G06Q 20/40145
USPC 705/3

(57) ABSTRACT

Disclosed are systems and methods for facilitating licensing of intellectual property rights and transfer of payments between intellectual property rights holders and users or licensees while shielding patient privacy. Information contained in a patient records database is restricted such that one or more fields of information are not available to one or more users of a privacy facilitating system. The patient records database containing patient records including patient identification information and diagnostic information is accessed along with a proprietary records database containing records of proprietary biomarkers and intellectual property rights holders of the proprietary biomarkers. The patient records database and the proprietary records database are queried to determine the presence of a proprietary biomarker in a patient record. A payment or escrow between a user and an intellectual property rights holder of the proprietary biomarker identified by the query is accounted for by the privacy facilitating system.

### CROSS-REFERENCE

The present invention is a continuation-in-part of U.S. patent application Ser. No. 13/371,422, filed Feb. 11, 2012, U.S. patent application Ser. No. 14/452,979, filed Aug. 6, 2014, and U.S. patent application Ser. No. 14/483,921, filed Sep. 11, 2014, the entire contents of which are incorporated herein by reference.

### FIELD OF THE INVENTION

This disclosure relates to methods and systems for facilitating the use of proprietary biomarkers across users and facilitating payment for the use of intellectual property rights between users of the systems and methods. The methods and systems of the invention further provide genetic data that can be securely searched and interpreted to generate results of genetic tests without the need to send large genome files over the internet.

### BACKGROUND

The proliferation of studies employing genetic information has led to the increasing use of genetic information for diagnostic purposes. Physicians often gather information from a patient to access risk for various conditions such that further diagnostic tests, follow-up visits and prophylactic measures can be employed in an efficient manner. For example, a physician utilizing their professional judgment may decide that a patient having a family history of breast cancer warrants more frequent mammogram screening. Similarly, a patient having certain combinations of physiological and demographic parameters, such as sex, age, weight and height, and blood test results, may require preventive measures to forestall the development of heart disease, diabetes or other lifestyle diseases.

Recent advances allow for genetic profiles of individual patients to be developed without prohibitive costs. In addition to genetic information, metabolic, proteomic, and lipidomic data are increasing available for profiling individual patients in a clinical setting. Genetic, metabolic, proteomic, lipidomic and metabolic data can serve as biomarkers amenable to profiling risk for various diseases or conditions. For example, mutations in the BRAC1 and BRAC2 genes are used in clinical settings as biomarkers for indication of risk for developing breast and ovarian cancer. Alternatively, an analysis of the pI and quantity of specific proteins can indicate an on-going disease process before other symptoms are readily apparent.

Diagnostic tests employing the use of biomarkers are frequently protected by intellectual property rights usually in the form of issued patent claims. Often times, identifying the presence of particular biomarkers does not necessarily require the acquisition of materials or equipment from the owner of the intellectual property associated with the biomarkers. By means of example, the presence or absence of specific genomic mutations can be performed through the use of multipurpose sequencing equipment or genechips. Further, the number of laboratories and clinical settings having access to equipment for determining genetic information and other biomarkers is becoming increasing widespread as cost barriers are decreased. As such, the benefit of diagnostic intellectual property rights can be accessed through the use of increasingly standardized equipment without the need for acquiring any materials from the rights holder of the intellectual property in question.

Licensing for the use of intellectual property traditionally results from direct negotiation between the rights holder and one or more users or licensees. However, transaction costs become prohibitive when many potential users or licensees are present on the landscape. This is particularly true when potential users or licensees occasionally perform diagnostic tests associated with particular intellectual property rights. In addition, a diagnostic service may perform a test resulting in a wide range of information such as whole genome shotgun sequencing (WGS) or a genome-wide SNP analysis using a genechip, where a wide range of potential proprietary markers useful for diagnostic purposes can be revealed. However, the individual or organization performing the diagnostic service is unaware how the generated information may be used by other parties or what intellectual property rights may be implicated. A further complication is that certain diagnostic tests may require the evaluation of biomarkers that may be covered by multiple patents belonging to multiple different rights holders. The acquisition of a comprehensive profile of biomarkers associated with a specific condition may implicate patents owned by several different entities thereby creating large transactional costs in directly licensing the relevant intellectual property.

The need to negotiate and manage a large number of licensing agreements is a disincentive for potential users or licensees to respect the intellectual property rights of patent rights holders. Alternatively, the need to manage a large number of licensing agreements can discourage the use, development and/or validation of biomarker-based diagnostic techniques, particularly in situations where it is difficult to determine all the rights holders that may be implicated. This challenge has been recognized as creating “patent thickets,” where commercial activity or legal compliance in an area is discouraged by a “thicket” of patent rights controlled by several different entities.

Transmitting genetic data across the internet raises security concerns, as the private genetic information may be intercepted by others. Further, whole genomes, or even portions of genomes, are extremely large files requiring a large amount of bandwidth and memory to transmit and store. Hence, there is a need for a system by which genetic data can be searched and interpreted to generate results of genetic tests without the need to send the large genome files over the internet.

### SUMMARY OF THE INVENTION

A system is provided for facilitating the use of proprietary biomarkers in genetic testing, and analyzing and reporting the results of genetic tests. The system can comprise a control server connected to a remote application, the remote application configured to obtain results of a genetic test. The control server can also be connected to a proprietary records database containing records of proprietary biomarkers and rights holders of the proprietary biomarker. A genetic data storage server containing genetic information for one or more patients can be in communication with the remote application. The remote application can be configured to send and receive data for conducting the genetic test. The control server can be configured to send and receive data for accounting for payment from a payer party to the rights holder. The control server can also be configured to account for payments from a payer party to the owner of the genetic data storage server.

The remote application can be collocated with the genetic data storage server on the cloud. The remote application can be configured to receive data from the genetic data storage server, and to carry out the genetic test. Alternatively, a third party scanning application can carry out the genetic test. A request for a genetic test can be initiated by the control server, or can be initiated by the third party scanning application. The control server can account for payments from a payer party to the third party and/or the rights holders, or from the third party to the rights holders. The third party scanning application can be collocated with the genetic data storage server.

The data storage server and the genetic data interpretations server can be selected from any one of a server, cloud, or web hosted data repository. The remote client and the control server can be selected from any one of a server, cloud, or web hosted application. The connections can be selected, but not limited to, from any one or more of TCP, UDP, VPN, SQL, sockets, or OS Messaging or other known connection technologies. One of ordinary skill in the art will further understand any present, future equivalent protocols are contemplated by the invention that are suitable to transmit secure and unsecure information between two collocated or non-collocated software instances.

A method for obtaining a genetic test and accounting for payments to rights holders is provided. The method can comprise obtaining genetic usage information from a payer party. The method can comprise proprietary records database, the proprietary records database containing records of proprietary biomarkers and the rights holders of proprietary biomarkers. The biomarkers required for a genetic test can be determined, and payment to the rights holders can be accounted for. The genetic testing can be carried out by a remote application, or can be carried out by a third party scan application.

The genetic usage information can comprise a prescription for a genetic test, the biomarkers to be searched during a genetic test, and/or the portions of the genome to be scanned during a genetic test.

Licenses for the use of proprietary biomarkers can be obtained before or after a request for a genetic test is created. These applications can be transferred to the scanning party in order to carry out the test. The system and methods can account for the payment of royalties or licensing fees associated with the biomarkers.

The system can also determine tests for new biomarkers based on the results obtained from tests including known biomarkers. Patients being tested for a particular disease can be separated into subgroups, and the genetic information of the patients in each subgroup searched to determine a correlation at various genetic locations to the disease.

### BRIEF DESCRIPTION OF THE DRAWINGS

FIG. 1 shows a schematic for a system for facilitating the use of proprietary biomarkers across users and facilitating payment for the use of intellectual property rights between users of the system.

FIG. 2 shows the functionality of user interfaces of the system.

FIG. 3 shows a flow chart for querying the system for the presence of proprietary biomarkers in a patient record.

FIG. 4 shows an exemplary relational database structure for a system for facilitating the use of proprietary biomarkers across users and facilitating payment for the use of intellectual property rights between users of the system.

FIG. 5 shows an exemplary hardware implementation for implementing the methods described herein.

FIG. 6 shows an exemplary large-scale hardware implementation for implementing the methods described herein.

FIG. 7 shows an overview of a system for providing biomarker test results.

FIG. 8 shows the genetic testing and reporting system according to one embodiment of the invention.

FIG. 9 shows the interactions of the servers and databases according to one embodiment of the invention.

FIG. 10 shows the interactions of the servers and databases including a third party request application.

FIG. 11 shows a genetic testing and reporting system including multiple genetic data storage servers and multiple sources of test requests.

FIG. 12 shows a genetic testing and reporting system with multiple genetic data storage servers and third party request applications.

FIG. 13 shows a genetic testing and proprietary biomarker accounting system with a third party requesting and conducting a genetic test.

FIG. 14 shows a genetic testing and proprietary biomarker accounting system with a control system initiating a request for a genetic test and a third party conducting the genetic test.

FIG. 15 shows a genetic testing and proprietary biomarker accounting system with a control system initiating a request for a genetic test and the same system conducting the genetic test.

### DETAILED DESCRIPTION

### Definitions

Unless defined otherwise, all technical and scientific terms used herein generally have the same meaning as commonly understood by one of ordinary skill in the relevant art.

The articles “a” and “an” are used herein to refer to one or to more than one (i.e., to at least one) of the grammatical object of the article. By way of example, “an element” means one element or more than one element.

The term “administrator” or “administrator user” refers to one or more individuals or parties responsible for maintaining the soundness and usability of the systems and methods described herein.

The term “authority” refers to having the right to access certain information stored in a system or database.

The term “biomarker” refers to a substance that whose quantitative or qualitative characteristics are used to determine a biological state or the presence or risk for a disease or condition. Biomarkers expressly include genomic information as indicated by a sequence or presence of certain nucleotide bases in a DNA molecule. Other express and non-limiting examples of biomarkers include quantitative or qualitative information regarding single nucleotide polymorphisms (SNPs), whole genome sequencing, genetic mutations, genetic linkage disequilibrium, metabolite information, proteomic information and lipidomic information.

The term “collocated” refers to two or more servers, databases, computers, software applications, or any other computing module being in the same location. The same location can mean on the same server, virtual instance, or computer, on a single intranet, or located in the cloud behind the same firewall. “Collocated” can also refer to two or more modules configured such that data can be transmitted between the two or more modules without transmitting the data over the internet. “Collocated” can also refer to two or more modules configured such that one of the modules is embedded within the other module.

The term “comprising” includes, but is not limited to, whatever follows the word “comprising.” Thus, use of the term indicates that the listed elements are required or mandatory but that other elements are optional and may or may not be present.

The term “consisting of” includes and is limited to whatever follows the phrase “consisting of.” Thus, the phrase indicates that the limited elements are required or mandatory and that no other elements may be present.

The phrase “consisting essentially of” includes any elements listed after the phrase and is limited to other elements that do not interfere with or contribute to the activity or action specified in the disclosure for the listed elements. Thus, the phrase indicates that the listed elements are required or mandatory but that other elements are optional and may or may not be present, depending upon whether or not they affect the activity or action of the listed elements.

The term “control server,” “control application,” or “CS” refers to a server or application configured to communicate with other servers, databases, or applications and to send and receive information from the other servers, databases or applications.

The term “database” refers to any organization of data or information that can be queried.

A “genetic data interpretations server” or “GDIS” is a server or database containing instructions on interpreting genetic or other biological data.

A “genetic data storage server” or “GDSS” is a server or database containing genetic or other biological data pertaining to one or more patients.

“Genetic usage information” refers to the information necessary for conducting a genetic test. As use herein, genetic usage information can refer to a prescription for a genetic test, the biomarkers to be searched during a genetic test, and/or the portions of the genome to be scanned during a genetic test.

The term “field” refers to a category of information entered into a database, where the field contains the same quality or type of data between records.

The term “information” refers to any algorithm, script, association, or any other data that can be stored by a computer.

A “prescription for a test” is a request by any party to search or analyze biological information.

The term “record” refers to a set of data present in a database that is associated with the same object such as a patient or biomarker.

A “remote client,” “remote client application,” or “RCA” is an application collocated with a genetic data storage server, and configured to receive instructions for interpreting genetic data and to interpret the genetic data according to the instructions.

A “third party request application” is an application collocated with a genetic data storage server and remote client that allows a request for a test to be made directly to the remote client.

The terms “diagnostic service provider, “diagnostic service user” and “diagnostic service provider user” refer to a party or organization that performs tests or other laboratory work to generate information concerning the presence of biomarkers in a patient.

The term “diagnostic information” or “raw diagnostic information” refers to information generated from a laboratory or other test that contains biomarker information, where information regarding a biomarker need not be tagged, highlighted or identified within the diagnostic information.

The term “physiological parameter,” “physiological data” or “physiological information” refers to here to refer to measurements of physiological functions that are not necessarily limited to the quantitative or qualitative of chemical substances and biomarkers. Non-limiting examples include sex, age, height, weight, blood pressure, heart atrial or ventricle pressure, heart rate, pulse, blood chemistry, glomerular filtration rate (GFR), EKG data, PET data, MRI data, and other data indicating the homeostasis or condition of the body.

The term “demographic parameter,” demographic data” or “demographic information” refers to information that can be used to predict or determine the health status or risk for a disease or condition for an individual that does not necessarily require the physical examination of the individual. Non-limiting examples include medical history of the individual or relatives of the individual, life-style habits such as diet, exercise, smoking alcohol consumption patterns or sexual activity, prior medical procedures or medical appliances such as a pacemaker or a stent, exposure to environmental health risks, etc.

The term “clinical parameter,” “clinical data” or “clinical information” refers to either physiological parameters or demographic parameters.

The term “payment” refers to the creation of a record detailing the obligation of one user of the systems or methods described herein to pay another user of the systems or methods described here. The actual receipt of financial funds is not necessary to complete a “payment.” Rather, the financial funds can be escrowed by an administrator or another party who receives funds from one user and holds them for benefit of another user. Alternatively, payment can be completed by updating a log, database, or sending a notification that payment is due from one party to another where the transfer of financial funds can occur at some later time. However, a “payment” can also occur by the transfer of financial funds from one user to another user.

The term “privacy rules” refers to a set of rules implemented to control the level of access or authority for information stored on a system or database.

The term “proprietary biomarker” refers to a biomarker associated with certain intellectual property rights, where such intellectual property rights can include patent claims providing for specific methods for using, detecting or deriving information from the biomarker as well as compositions of matter for detecting the biomarker.

The terms “restricting,” “restricting information,” and similar terms refer to limiting the access to information stored on the system described herein or accessible using the methods described herein to specific users.

The terms “rights holder” or “rights holder user” refers to a user or party that is the owner of intellectual property rights for which the systems and methods described herein are providing payment for the use of subject matter within the domain of those intellectual property rights by other users or parties. Intellectual property rights specifically include patent claims but can also include other recognized intellectual property rights.

The term “payer party” or “payer party user” refers to an insurer or other party that is responsible for at least a partial payment to another user of the system and methods described herein. The payer party in addition to an insurance company can include a patient receiving the benefit of a diagnostic service.

The term “patient” or “patient user” refers to an individual, human or animal, from whom diagnostic information concerning biomarkers is taken.

The term “physician” or “physician user” refers to an individual, regardless of any licenses issued by a governmental authority, which uses the systems or methods described herein to identify or access biomarkers for purposes of making a medical evaluation using the systems or methods described herein.

The term “user” refers to any party or agent of a party who sends or receives information from the systems described herein or by means of the methods described herein.

The term “table” refers to an organization of data in a database.

The term “foreign key” refers to a parameter that serves as a restraint on data that can be entered on a database table.

The term “proteomic” refers to information relating to any of the quantity, identity, primary structure (sequence of amino acid residues), pI (isoelectric point), or any other qualitative information related to proteins present in a biological sample.

The term “lipidomic” refers to information relating to any of the quantity, identity, chemical structure, oxidation state or any other qualitative information related to lipids present in a biological sample.

The term “patient identification information” refers to any data that contributes to the personal identity of an individual.

The term “relational database” refers to a database that can be queried to match data by common characteristics found within the dataset. The term “cloud” refers to any network or server that exists as a separate entity from the internet.

The term “diagnostic test” refers to any process performed on a biological sample that results in information, termed “diagnostic information,” about the sample. The “diagnostic information” can include, but is not limited to, genomic, proteomic, and lipidomic information regarding the biological sample and standard blood tests for determining blood chemistry.

The term “server” means any structure capable of storing digital information. As used herein, “server” can also refer to a database, application, intranet, virtual instance, or other digital structure.

### Privacy Facilitating System for Transferring Payment to a Rights Holder

The systems and methods disclosed herein provide for the linkage of patient-and/or specimen-centric molecular, genetic or other biomarker data to proprietary information useful for making medical diagnoses or risk assessments. The described systems can search multiple databases, indexes, catalogs or databases, and in various languages, for patented or proprietary genetic biomarkers and related information to populate and maintain the system database(s). Genetic biomarkers can include polymorphisms, linkage disequilibrium of alleles at multiple loci, and mutations in genomic or mitochondrial DNA. The systems can receive input from a third party database or databases where the third party database can automatically upload new proprietary genetic information. The system database(s) contains proprietary genetic information and/or biomarkers including owner information, clinical, diagnostic, and treatment data. The system database(s) can further contain error logs and/or audit logs to document data inconsistencies in the system database(s). Those skilled in the art will readily recognize that the data structure for maintaining the databases is not particularly limited and can, for example, employ a relational database management system or an object-oriented database management system.

The system also has a component for storing patient information in a system patient records database(s). A physician user or another user can enter the patient's clinical data including medical history, attributes, physiological parameters, demographic parameters and/or laboratory test results in appropriate fields of a database. The system patient database(s) also contains information for genetic biomarkers or other biomarkers associated with specific patients. In some cases, a patient's biomarker information, such as, for example, Single Nucleotide Polymorphism (SNP) information, will be unknown at the time of examination or diagnosis by a physician. Therefore, in certain embodiments, the physician or another user can enter the patient's biomarker information into the system patient database(s) at a later time. In light of the increase in personalized medicine, patients are increasingly encouraged to actively engage in the collection and management of their personal health records. As such, in certain embodiments described herein, a patient-centric model for determining usage of proprietary biomarker information is employed where the determination of the need for payment to stakeholders can be triggered on the patient level rather than as a result of a licensing agreements or other relationships between the rights holders in particular biomarkers and particular diagnostic labs or physicians.

In other embodiments, diagnostic laboratories or physicians can perform required tests to determine patient biomarkers and directly upload the information into the system patient records database(s). The system can then correlate the patient's clinical and/or biomarker information with information in the system database(s), and/or access one or more public or private domain databases and generates a match for any proprietary biomarker information. In addition, a patient's clinical and/or demographic information can be compared with other patient records in the patient records database(s) to determine whether common attributes are present in the population identified by the system as sharing a common SNP or other biomarker for use in diagnosis and treatment. Information can then be communicated to the physician indicating that the individual shares attributes with a population of individuals having a common SNP or other biomarker. Accordingly, this method provides a means for identifying patients possessing genetic information and biomarkers that might read on proprietary uses and methods of utilizing the information. Further, notice to insurance companies or payer parties and payments to stakeholders of proprietary information can be made in an automated fashion.

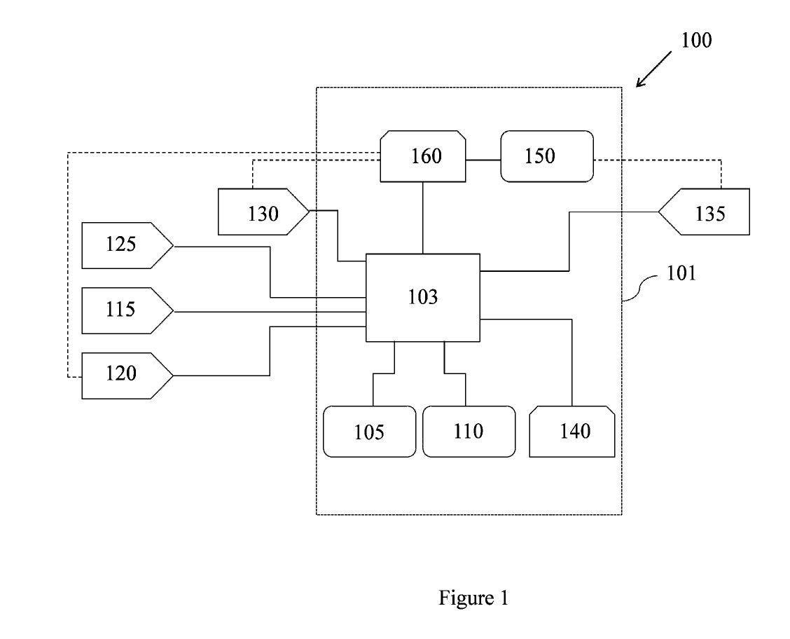

With reference to FIG. 1, systems for implementation of the innovations disclosed herein will be described. In FIG. 1, a system 100 having a trusted server 101(inside dashed rectangle) is provided to control access to one or more databases and manage the transfer of payment between users. Those skilled in the art will understand that trusted server 101 may be any configuration of one or more processors 103 (rectangles), data storage devices (rounded rectangles) and servers for communication capable of performing the functions disclosed herein. The system 100 can host various user interfaces (pentagons) and functional facilities (hexagons). The trusted server 101, and more particularly the one or more processors 103, controls access to information stored in a proprietary records database 110 and a patient records database 105 according to privacy rules that govern access to information contained in the proprietary records database 110 and the patient records database 105.

The patient records database 105 contains individual patient records that include patient identification information and diagnostic information, where each patient record is associated with a particular individual patient. The individual patient identification information can include such fields as first and last name, data of birth, physician information, address, social security or other identification number, or any other information that may potentially give an indication as to the identity of the patient associated with the identification information. Those skilled in the art will appreciate that the patient records database 105 is not limited to any particular device or hardware.

The proprietary records database 110 contains records of proprietary biomarkers, information regarding the rights holders of the biomarkers, and data or rules for the use of the biomarkers to diagnose specific diseases or conditions or indicate risk for specific diseases or conditions. In addition to biomarkers, the proprietary records 110 database can optionally contain demographic or clinical information that can be used to evaluate risk for specific diseases or conditions. Many biomarkers have increased predictive power when used in combination with certain demographic and/or physiological parameters. For example, the presence of a specific SNP may indicate an increased risk for certain diseases or conditions in combination with certain demographic and/or physiological parameters or information, such as age, sex, weight, height, blood pressure, EKG characteristics or certain prior medical history such as a vascular stent. Alternatively, the presence of specific SNP may indicate a particular therapeutic regimen such as administration of drug or use of a medical device. In particular, the presence of a SNP may indicate the implantation of an Implantable Cardio defibrillator Device (ICD). In some instances, the patent claims of a rights holder may only extend to the use of one or more biomarkers in combination with certain demographic and/or physiological parameters. In such instances, the intellectual property rights of a rights holder may only be implicated when a biomarker is present in a patient record in conjunction with certain demographic and/or physiological parameters.

A function of the system 100 is that access to the information in the patient records database 105 is restricted. Regarding information in the proprietary records database 110, the extent and owners of intellectual property rights, particularly patent rights, is usually publically known. As such, access to information in the proprietary records database 110 does not need to be restricted in certain embodiments. In particular, access to patient identification information is restricted to protect the privacy of the patients. In some embodiments, access to patient identification information is only granted by the privacy rules to a patient's physician and optionally a payer party having responsibility for a patient. Access to demographic and clinical information and biomarkers can be granted for the purposes of making comparisons between populations, as described above.

Medical information is oftentimes regarding as personal by many individuals, where disclosure of medical information that can be associated with a specific individual is often times regarded as a violation of trust or an intrusion into personal privacy under social norms. In addition to the social sensitivity of medical information, physicians and other medical providers can have ethical or legal obligations to shield the privacy of patient medical information. Still further, the presence of certain biomarkers, particularly genetic information, can be used to discriminate against specific patients. For example, knowledge of particular genetic information may be used by employers to discriminate in hiring or by health insurers to decline coverage. The potential illegality of such discrimination is not an absolute deterrent to its occurrence.

Medical information is entered into individual records in the patient records database 105 via a physician user interface 115 or a diagnostic service provider interface 120. As shown in FIG. 1, the physician user interface 115 is in communication with the trusted server 101. The physician user interface 115, in certain embodiments, is located on an internet web server where the physician user interface 115 can be accessed using a standard HTML web browsers. In other instances, the physician user interface 115 can be a specialized executable program running on a processor remote from the trusted server 101 or processor 103, where communication with the trusted server 101 is accomplished through the internet or other network.

The physician user interface 115 is accessible by a user having authentication credentials to identify the user as a physician user 115. A physician user 115 is a health care provider or an individual supervised by the health care provider who is authorized by a patient to enter or populate information associated with a specific patient record in the patient records database 105. A physician user 115 can have the ability to enter information into a patient record including patient identification information and demographic information either manually or in an automated fashion through electronic data provided by a separate electronic records system maintained by the physician user. Security rules can be set such that the physician user has access to the information contained in a patient record for which the physician has authority but not to identification information for patient records for which the physician does not have authority.

The authority of a physician user for a particular patient record in the patient records database can be established automatically upon the establishment of a new patient record. That is, the possession of identifying patient information used to establish the patient records presumes that the physician user has authority concerning that patient. Alternatively, the authority of a physician user can be verified or certified by a physician user already having access to the system, for example, where a patient switches medical providers. Alternatively, a patient user interface 125 can optionally be provided to allow the patient to designate the authority of a specific physician user. In certain embodiments, the patient user interface 125 does not have access to change the content of the patient records in the patient records database 105 to prevent an unsophisticated user from inadvertently changing the content of the patient record.

Optionally, the trusted server 101 can also be accessed through a diagnostic service provider interface user 120. Biomarkers are physical traits that are determined through laboratory testing often requiring sophisticated equipment. As such, a specialized testing laboratory or diagnostic service may be employed to directly perform diagnostic tests and generate diagnostic information. The diagnostic information can be reported to the physician whereupon the physician may update the diagnostic information contained in a patient record through the physician user interface 115. Alternatively, the diagnostic service provider user interface 120 may be provided to allow the testing laboratory or diagnostic service to directly update the diagnostic information of a patient record in the patient records database 105. The diagnostic service user interface may be accessible through an HTML viewer or a specialized executable program in a manner similar to the physician user interface 115.

The privacy rules operating on the trusted server 101 can be configured to allow a physician user a large degree of access to the patient records of the patient records database 105 for which the physician has authority, since a physician generally requires access to all of the patient identification information and diagnostic information contained in a patient record. In contrast, a diagnostic service provider typically does not need to have any significant access to patient information. As such, the privacy rules can be set to allow the diagnostic service provider to use the diagnostic service provider user interface 120 to upload diagnostic information to the patient records database 105. In certain embodiments, the diagnostic service provider need not be informed or have access to basic patient identification information such as name and date of birth. Rather, unique and/or one-time reference number for the particular diagnostic test can be provided to the diagnostic service provider while the trusted server 101 can correlate the reference number with a particular patient record to be updated.

Additional users of the system include a payer party user and a rights holder user, who access the trusted server 101 through a payer party interface 130 and rights holder interface 135, respectively. A function of the system 100 is to allow for the transfer of payment from a payer party to a rights holder when proprietary biomarker information is accessed through the physician user interface 115. The process for a physician to access proprietary biomarker information using the system 100 will be described in greater detail below.

Health care services, including diagnostic tests for biomarkers and physician treatment and advice based upon the presence of biomarkers, are often covered by health insurance where the patient receiving the services is not responsible for 100% of the necessary payment. The payer party user in some embodiments is a health insurer or other third party payer having responsibility for a specific patient represented by a patient record in the patient records database 105. Further, the patient themselves may also be responsible for all or part of the payment due for accessing certain proprietary biomarkers in the course of their care by a physician. As such, the payer party can further include a patient in addition to or in place of an insurer.

The privacy rules operating on the trusted server 101 can be configured to allow the payer party user access to only information necessary to verify the obligation to authorize a payment or review the validity of payments already sent. In some embodiments, the payer party user need not have access to the nature of the diagnostic query or test actually performed, rather only a guarantee that the service performed is of the type normally authorized by a specific health plan. As such, a patient record in the patient records database 105 can contain details of the identity of a payer party for that patient along with details of the extent of medical coverage provided by the payer party. A payer party user can choose to receive notification, as set in the privacy rules, that an insured patient has received an evaluation based upon proprietary biomarkers covered by insurance and choose to allow payments to processed without knowing the precise identity of the biomarkers concerned, although the payer party user can require the identity of the insured patient to verify coverage. As such, the system 100 can guarantee a high degree of patient privacy for sensitive medical information.

Typically, payer parties and insurers have access to the nature of medical diagnostic tests performed on insured persons, where such medical diagnostic tests are billed to the insurer. Here, a diagnostic service provider can still directly bill a payer party or insurer directly for their services performed as is the usual custom. For example, a diagnostic service provider can bill a payer party or insurer for the performance of a genome-wide SNP analysis using a genechip or similar test or a blood protein analysis; the nature of these diagnostic tests may be directly reportable to the payer party or insurer. However, as will be explained below in greater detail, the system 100 allows a physician user to access information concerning specific biomarkers measured by such tests. While a payer party user or insurer may have knowledge that a genome wide SNP analysis was performed on a specific insured patient, the payer party user's access to knowledge that a physician specifically evaluated biomarkers related to heart disease, cancer or other specific diseases or conditions can be shielded using the privacy rules of the system. Alternatively, payments to and from a diagnostic service provider user can be made through the system 100 as necessary to protect confidential patient information.

Similarly, a rights holder user typically does not require access to the identity of a patient or physician that has accessed information related to specific proprietary biomarkers. As such, the privacy rules can be configured to allow the rights holder user interface 135 to access information regarding the frequency of use of their proprietary biomarkers and verify the receipt of proper payment. However, the identification information of patients as well as the names of physicians and insurers can be shielded by the system 100 as required.

Those skilled in the art will readily understand that the privacy rules described above can be modified from the description above as required by certain users. For example, a payer party user can require a greater degree of information to authorize or review payments for the use of certain proprietary biomarkers, and the privacy rules can be modified to vary the degree of access to identification information and diagnostic information contained in the patient records database 105. The system 100 facilitates anonymous transfer of rights to use proprietary biomarkers and the anonymous transfer of payments to rights holders in such proprietary biomarkers. The invention specifically contemplates the use of any set of privacy rules that fulfill the aforementioned criteria.

The system 100 can include an optional notification server 140 that functions to send an email or other notification to any user containing the availability of new information from the system or a notice that new information is available upon accessing the appropriate interface. Such notification can be done using email or like notification or displayed by prompt upon a user logging into the system 100 after new information becomes available.

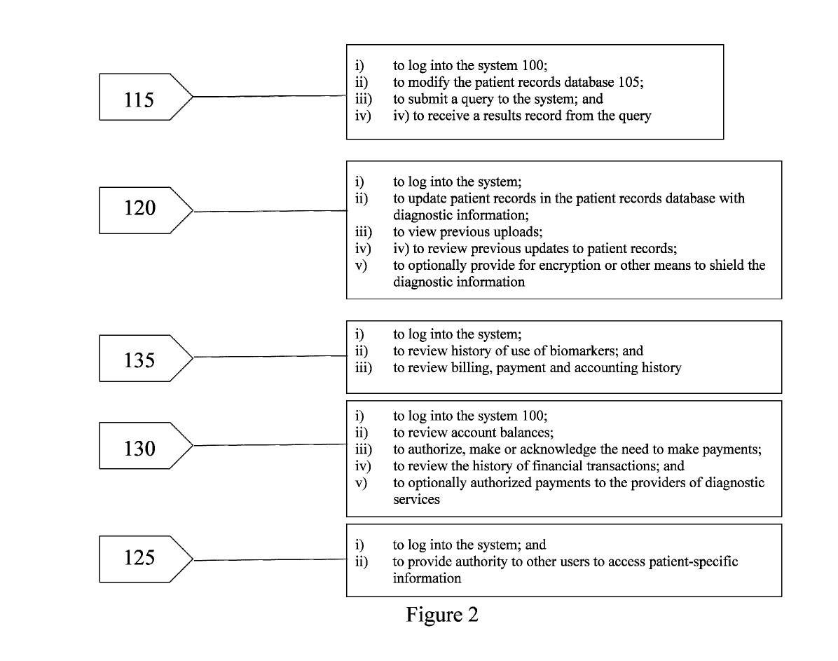

With reference to FIG. 2, the access to the patient records database 105 and privileges granted to different categories of users will be discussed. The physician user interface 115 provides the ability i) to log into the system 100; ii) to modify the patient records database 105 for authorized patient records including patient identification information and diagnostic information; iii) to submit a query to the system 100; and iv) to receive a results record from the query by email or by logging into the system 100. The diagnostic service provider interface 120 provides the ability i) to log into the system; ii) to update patient records in the patient records database 105 through use of a reference ID number and/or a doctor ID number with diagnostic information; iii) to view previous uploads; iv) to review previous updates to patient records and v) to optionally provide for encryption or other means to hide the diagnostic information from a technician performing the transfer of data to the system 100.

The rights holder user interface 135 provides the ability i) to log into the system; ii) to review history of use or matches of proprietary biomarkers associated with the rights holder user; and iii) to review billing, payment and accounting history for use or matches of proprietary biomarkers. The payer party user interface 130 provides the ability i) to log into the system 100; ii) to review account balances for insured patients; iii) to authorize, make or acknowledge the need to make payments to rights holder users; iv) to review the history of financial transactions; and v) to optionally authorized payments to the providers of diagnostic services. The patient user interface 125 provides the ability i) to log into the system; and ii) to provide authority to other users to access patient-specific information.

### Querying the System

As describe with regards to FIG. 1, the system 100 contains a trusted server 101 that functions to interact with users and implement privacy rules to control access to the patient records database 105. The physician user interface 115 and optionally the diagnostic service interface 120 are used to populate the patient records of the patient records database 105 with diagnostic information. The diagnostic information can contain a large quantity of data that requires analysis to determine the presence of proprietary biomarker information. For example, the diagnostic information can contain genome-wide genetic information that requires parsing to identify the presence of certain alleles, SNPs or mutations.

In certain embodiments, the diagnostic information is only accessed in regards to a specific query from a physician initiated through the physician user interface 115. As such, only biomarker information that is used by a physician to assess the risk for a specific disease or condition of concern is granted to the physician user, where such access results in the potential need for payment to a rights holder. For example, if genome-wide information is taken for a patient and present in the diagnostic information in the patient record, many potential proprietary SNPs or other biomarkers can potentially be present in the acquired diagnostic information. However, it would be impractical under most scenarios to require payment for all the proprietary SNPs that may be present in an individual patient's genome as determined through genome-wide diagnostic information. Further, the intellectual property of rights holders may only extend to certain uses of particular proprietary SNPs rather than only detection during a diagnostic test. Further, intellectual property rights may only extend to multiple biomarkers and/or clinical parameters present in one patient for the indication of risk for a specific disease or condition.

As such, a physician user can access the diagnostic information in a patient record by querying the system 100 with at least one search criterion. The search criterion can be specific biomarkers and/or a search for biomarkers that are correlated with specific diseases or conditions. Search algorithms and methods to parse through genetic information are known. Other biomarker data, such as lipidomic and proteomic data, can also be searched in response to a query.

The proprietary records database 110, in addition the identity of specific biomarkers, can contain information regarding specific diseases or conditions associated with certain biomarkers. Often, these specific diseases or conditions are specified in the patent or other intellectual property grant upon which the associated rights holder relies upon. Specific diseases or conditions can be assigned unique codes for use within the system 100 to avoid the uncertainty of key word searching.

By means of a non-limiting example, a physician can request a whole or partial genome evaluation of a patient, where the generated diagnostic information is loaded into the patient record in the patient records database 105. The physician can then submit a query to the system 100 through the physician user interface 115 to search for SNPs associated with the risk for heart disease. In certain embodiments, the trusted server 101 or another processor can iteratively search the genetic information contained in the diagnostic information for proprietary biomarker SNPs and/or other SNPs associated with heart disease. Known search engines and parser algorithms such as BLAST, BioJava (http://www.biojava.org/wiki/Main Page) or BioParser (http://bioinformatics.tgen.org/brunit/software/bioparser/) can be used to search the diagnostic information for relevant proprietary biomarkers. A sub-database table or results record can be populated in the relevant patient record of the patient records database 105 with the information extracted using the parser algorithm, which will eliminate the need to parse the raw diagnostic data only one time to extract biomarkers relevant to the query.

Upon the identification of proprietary biomarkers in response to a physician query, the intellectual property of one or more rights holders can be thereby used and the process to transfer, to account for or to escrow a payment to the rights holders can then be initiated. The trusted server 101 updates a payment log or database 150 to credit an appropriate rights holder user with a monetary amount for use of proprietary biomarkers upon a successful query by a physician user that returns proprietary biomarkers in response to the query. A payment facility 160 can be present to process payments from a payer party user to a rights holder user. Payment can be automatic or only after authorization by a payer party user using the payer party user interface 130. In certain embodiments, the system 100 does not complete an actual transfer of funds between bank accounts. Rather, payment is completed for the purposes of the invention and the attached Claims when a balance in a payment log or database 150 is updated reflecting the obligation of a payer party user to remit funds. Funds can be remitted by payer parties to an Administrator of the system 100 or another party in escrow on a periodic basis, at which time the Administrator can send funds to the appropriate rights holders, and the remittance of the payment noted in the log or database 150. In other embodiments, the payment facility 160 can be programmed with the banking information of the relevant users and periodically initiate payment between the payer party users and the rights holder users using the automated clearing house (ACH) or other electronic means in a manner that ensures the anonymity of the rights holder user and the payer party user. Funds may be first transferred through a bank account set-up for the administration of the system to protect the identity of the payer party, which may in turn reveal patient identification information.

If one or more rights holder users own rights to the returned proprietary biomarker information from the query in the results record, an agreed upon calculation can be used to divide payment from a payer party user automatically between the rights holders of the proprietary biomarker information using the system 100. For example, a first rights holder user can own patent claims for a first SNP biomarker to indicate heart disease risk, and a second rights holder user can own patent claims for a second SNP biomarker to indicate heart disease risk. The system 100 and the payment facility 160 can automatically and simultaneously inform both the first and second rights holder users of the found biomarkers in one patient, and then a pre-arranged calculation can be performed to apportion payments to each rights holder user. In this manner, individual patient costs can be distributed across all patients using the system 100 whereby using the systems and methods of the invention, the rights holder users are blinded to specific patient identification information.

An additional feature of the system 100 is that the use of proprietary biomarkers can be attributed to a specific patient. That is, the patient record can be annotated to indicate, for example by means of the results record, that the use of particular biomarkers have been accessed and paid for in the past. In certain embodiments, a patient can go to another physician to get a second opinion and/or the same or a different diagnostic test can be performed that implicates biomarkers for which payment has already been made in the past. The patient can be granted a limited license to allow for the future use of a proprietary biomarker accessed in the past. As such, the patient can get a second physician's opinion and/or an additional diagnostic test without additional payment.

For example, a patient record can be updated to indicate proprietary biomarkers that have been accessed in the past and payment previously made. If a future query is made that generates a results record containing a previously accessed biomarker, the system can be set to allow further usage of that proprietary biomarker without additional payment. In certain embodiments, the length of time for which future use can be made of a previously accessed proprietary biomarker can be limited to a set period of time. The patient record can be annotated to indicate a date that a biomarker was first accessed to allow the calculation of the expiration a license for future use, where the amount of time rights to use of a biomarker can be indicated in the proprietary records database 110.

The system can also correlate a patient's demographic and physiological information with information in the system and/or accessed from one or more public or private domain databases, such as a SNP consortium, and generating a result set that includes a suggestion for genetic, proteomic, and/or other type of diagnostic testing. In a further embodiment, the present invention also relates to displaying the identified correlation to aid in determining the statistical significance of the identified correlation. In addition, the patient's diagnostic, clinical and physiological information may be compared with other patient records in the database to determine whether common attributes are present in the population identified by the system of the invention as sharing common biomarkers for use in diagnosis and treatment. Information can then be communicated to the physician indicating that the individual shares attributes with a population of individuals having a common biomarker. Such information can be included with the results record generated the physician's query.

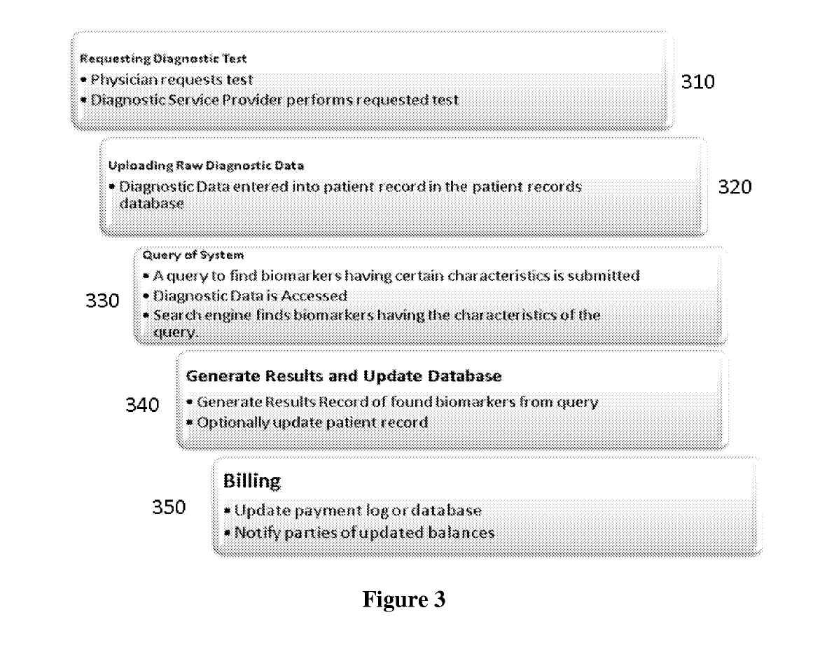

With reference to FIG. 3, an exemplary process to query the system 100 for proprietary biomarkers and remit payment to a rights holder user in a blinded fashion will be described. In step 310, a physician requests a certain diagnostic test be performed, where the raw diagnostic data generated by the diagnostic test can include proprietary biomarkers. In step 320, the raw diagnostic data is uploaded to the system 100 for addition to a specific patient record in the patient records database 105. The raw diagnostic data can be uploaded by a diagnostic service provider and the patient record identified by a reference number that maintains the anonymity of the patient.

In step 330, a physician queries the system to look for particular biomarkers in the raw diagnostic data and/or to look for biomarkers predictive or indicative for risk for specific diseases or conditions. The patient's record database is accessed by the system 100 and the raw diagnostic data is parsed to identify proprietary biomarkers having characteristics conforming to the query. In step 340, a results record is generated containing biomarkers returned by the query and optionally the physician and/or a payer party user having responsibility for the patient or rights holder user associated with the propriety biomarkers are notified. The patient record can be updated with the contents of the results record or the query. In step 350, a payment log or database is updated to reflect the need for a payment between a payer party user and a rights holder user in a blinded fashion.

### Database Structure

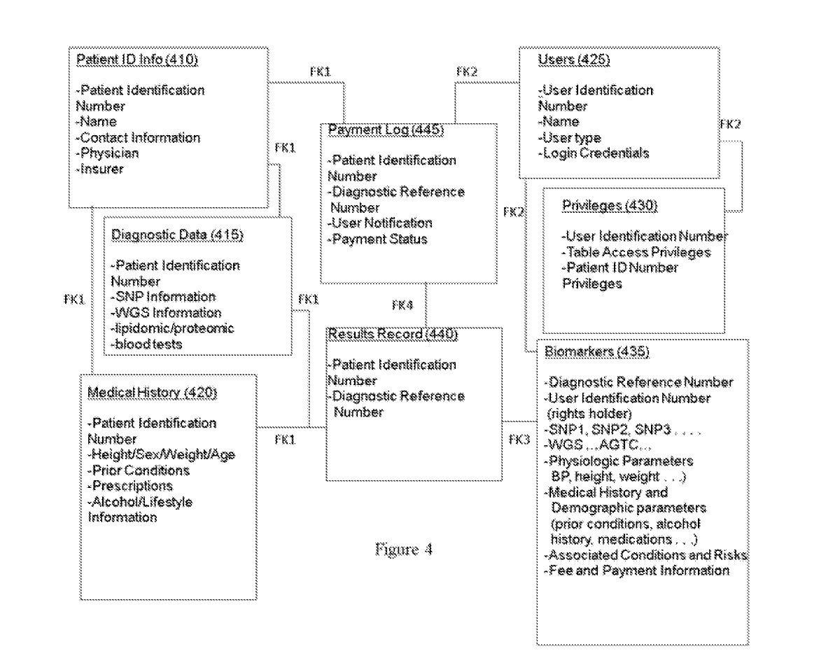

FIG. 4 shows a non-limiting example of a database structure that can be employed in conjunction with the methods and systems described herein. Those skilled in the art will readily recognize that other database structures and organizations can be equally employed to practice the methods and systems described here. FIG. 4 illustrates a structure for a relational database that can be accessed and search queries obtained through the use of structured query language (SQL).

FIG. 4 shows a relational database having several Tables having rows and columns related to the category stated in the header. As presented in tables 410-445 in FIG. 4, exemplary attributes for each table are listed. The first attribute in each of tables 410-445 can be used as a key to relate information in that table to another related table using SQL. More specifically, the first attribute in each table can serve as a candidate key that is not duplicated within any one table. The organization of tables 410-445 will now be described.

Table 410 contains patient identification information. The attributes can include a patient identification number, the patient's name, contact information, physician name and/or physician user identification number, and insurer information and/or payer user identification number. Those skilled in the art will readily recognized that other attributes may be contained in patient identification table 410. As described, protection of the information contained in the patient identification information table 410 is strictly controlled in order to protect patient privacy. As such, sensitive information regarding patient identity can be segregated on table 410 to prevent unauthorized disclosure of such information.

Data and information associated with specific patients that may have less strict control over access can be stored on tables separate from table 410. As shown in FIG. 4, a diagnostic data table 415 can be provided. In addition to containing the patient identification number attribute, table 415 can contain additional attributes related to various diagnostic tests performed on the patient associated with a patient identification number. Examples of attributes that can be provided on the diagnostic data table 415 include the presence of specific SNPs, WGS, WES, or targeted gene information, proteomic and/or lipidomic information, and results of blood tests reflecting blood chemistry. Similarly, table 420 can contain information regarding a specific patient's medical history. In addition to containing the patient identification number attribute, table 420 can contain additional attributes such as previous diagnoses, current prescriptions, height, weight, age, and other attributes typically contained in medical records. Specific attributes of tables 415 and 420 may be represented by a reference numeral rather than a word string to facilitate querying of the system.

Tables 415 and 420 can be constrained through the use of a foreign key, shown as FK1 in FIG. 4. The foreign key FK1 can be used to insure that a patient identification number attribute on tables 415 and 420 occurs and has a valid entry on patient identification information table 410. The foreign key FK1 can also be used as a constraint to ensure that a patient identification number contained on other tables, as shown in FIG. 4, occurs on tables sharing a relationship. For example, the foreign FK1 can constrain the system or any user from entering information on diagnostic data table 415 with a patient identification number that does not appear as an attribute on patient identification information table 410.

As described, the systems described herein provide for various user interfaces for interacting with the system including entering information in the system and submitting a query. User table 425 can have attributes including user identification number, user name, user type, and login credentials. The user type (e.g. physician user, rights holder user, etc.) can be used by the system to present the appropriate user interface to a user logging onto the system. The user table 425 can be related to a privileges table 430 that defines the access rights within the privacy rules operating on the system including which patient identification numbers certain users have privileges and concerning access to patient identification table 410. Foreign key F2 can be implemented to constrain privilege table 430 to only contain user identification number attributes that appear in user table 425.

Biomarkers table 435 can be further related to user table 420. Biomarkers table 435 contains the combination of biomarkers and other information that represent the intellectual property owned by specific rights holder users. In general, the user identification number attributes on table 435 are associated with rights holder users. A diagnostic reference number can be provided as an attribute that represents discrete diagnostic tests that represent an intellectual property right held by a rights holder user.

For example, a certain combination of biomarkers can represent an increased risk for cancer. By means of illustration, a rights holder can be the holder of a patent claim that recites that the presences of a G nucleotide at SNP1, and a C nucleotide at SNP2, and a weight above 200 pounds for males represents an elevated risk for certain kinds of cancers, where SNP1 and SNP2 represent specific genomic loci in the genome. The biomarkers SNP1 and SNP2 and the clinical parameters regarding weight and sex can be organized in the same row of biomarkers table 435 associated with a unique diagnostic reference number attribute. FIG. 4 shows non-limiting examples of biomarkers including SNPs, WGS, proteomic and/or lipidomic information, physiological parameters, and demographic parameters that can be associated with specific intellectual property rights. The rows of table 435 can also contain fee information associated with the use of the diagnostic test represented by that row of the table 435.

As described above, the system can be queried to identify patients having specific biomarkers or combinations of biomarkers and/or clinical parameters that represent an elevated risk or decreased risk for certain diseases and conditions. The search engine associated with the system can search for the concurrence between the specific intellectual property rights stored in biomarkers table 435 with the information stored on the diagnostic data table 415 and the medical history table 420. As described, the system, for example, can be queried to determine if a specific patient has any biomarkers and/or clinical parameters associated with an increased risk for cancer. The system will then systematically search the appearance of any combination of biomarkers and/or clinical parameters associated with a diagnostic reference number annotated to be correlated with a risk for cancer against the information stored in diagnostic data table 415 and/or medical history table 420.

Any matches from a query can be recorded in results record table 440 as shown in FIG. 4. The results record table 440 can list the patient identification number for the patient having at least one match to a diagnostic reference number. A foreign key FK3 can be employed to constrain results record table 440 to contain only diagnostic reference numbers that appear on biomarkers table 435. A payment log table 445 can be provided to record activity of the payment facility 160. The payment log table 445 can contain the patient identification numbers and diagnostic reference numbers representing a match from a query as in results record table 440. A foreign key FK4 can be provided to constrain payment log table 445 to only contain entries for combinations of patient identification number attributes and diagnostic reference number attributes that occur in results records table 440. The payment log 445 can contain further attributes concerning the status of notification to users regarding payments and the status of any pending payments between any users of the system.

### Hardware

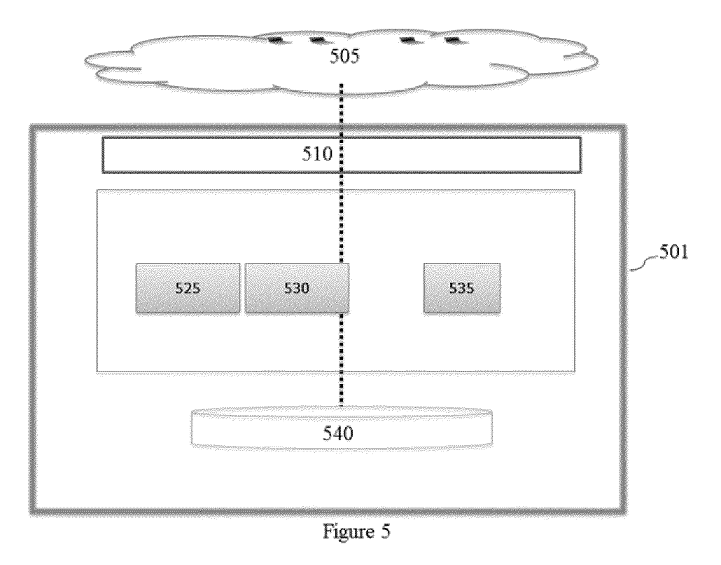

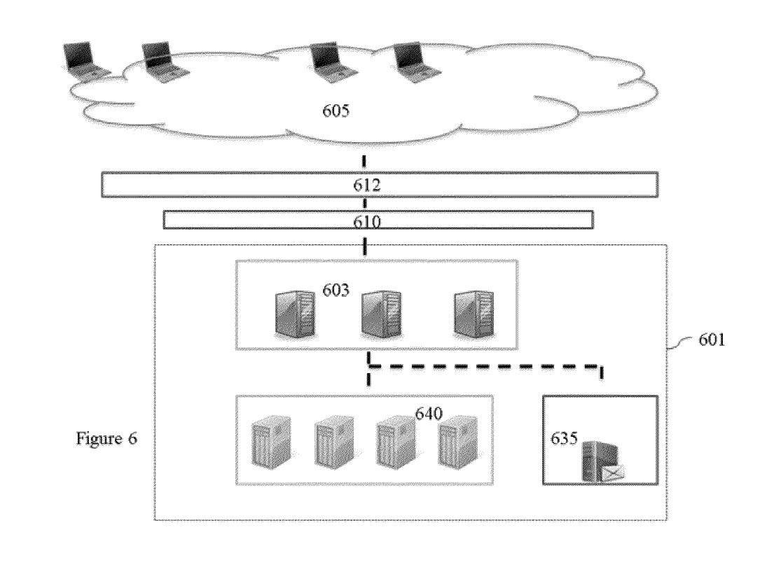

FIG. 1 illustrates the functionality of the systems and methods disclosed herein. The above-described functionality can be implemented on any hardware system adaptable to carrying out the above described functions. However, non-limiting examples of hardware systems to carry out the invention are presented in FIGS. 5 and 6.

FIG. 5 shows a hardware implementation that can be deployed on a single server 501, where the single server can be laptop or desktop computer. The server 501 serves as the trusted server 101 described in FIG. 1. Users 505 of the server 501 can communicate with the server 501. Communication can be accomplished via the internet or by other network means; an internet connection is not required to practice the invention. In certain embodiments, users 505 can communicate with the server 501 using widely-available HTML viewers.

Users 505 first communicate with a security module 510 implemented on the server 501. The security module 510 can be a form-based authentication where users are verified using a username and password combination. A username and password combination will identify the user 510 as a physician user, diagnostic test provider, patient user, payer party user or rights holder user and implement the proper interface and related privacy rules to control access to information. Alternatively, access to the server 501 can be granted based upon the user uploading a security file containing encrypted identification information.

The server 501 implements a web server that includes a user interface (UI) 525 that is presented to the user 505. The UI 525 is not limited to any particular software, standard or language. In certain embodiments, the UI 525 can be based on a JavaScript Library including HTML5, css3.0 and a robust JavaScript Library Toolkit that supports Web 2.0 standards. The UI 525 can therefore be a graphical interface that can be intuitively operated by the user 505. As described, one or more parser algorithm tools or search engines 530 can be implemented on the server 501 to parse genetic data. In one embodiment, the parser algorithm tool 530 can be BioJava (http://www.biojava.org/wiki/Main Page), which has the advantage of being readily implemented with a JAVA-based web server. In another embodiment, the parser algorithm tool 530 can be BioParser (http://bioinformatics.tgen.org/brunit/software/bioparser). Since BioParser is written in PERL, a wrapper is required to implement BioParser with a JAVA-based web server, for example, JPL or JNI. The notification server 140, described in FIG. 1, can be implemented with an included JAVA mail client 535 to send notifications to users 505 even when a user 505 is not logged onto the server 501. The mail client 535 can also implement the payment facility 160 where a payer party user and/or rights holder user can be notified of the obligation for a payment to be made in a blinded fashion.

The patient records database 105, the proprietary records database 110 and the payment log or database 150 can be accommodated on a storage device 540. The databases stored on storage device 540 are not limited to any particular structure. In some embodiments, the patient records database 105, proprietary records database 110 and the payment log or database 150 are structured to be assessable and/or queryable using structured query language (SQL) used to maintain relational databases. In one embodiment, the databases use a relational database management system such as the Oracle 8i™ product (version 8.1.7) by Oracle. In another embodiment of the databases, object-oriented database management system architecture is used.

FIG. 6 shows a hardware implementation that employs several processors for a large-scale implementation. The function of the one or more processors 103 described in FIG. 1 is carried out by one or more processing units 603 that provide the computational power to implement a UI, a parser algorithm and a security module 610 and provide services to users 605 in the same manner as described above in FIG. 5. A load balancer 612 is also present to manage work flow in implementations where more than on processing unit 601 is present. The load balancer 612 divides the workload multiple processing units 601. If a fault occurs with one of the processing units 601, the load balancer 612 can automatically route requests from users 605 until the fault has been corrected.

The processing units 601 can access a storage area network (SAN) that houses the patient records database 105, the proprietary records database 110 and the payment log or database 150. A separate mail server 635 containing dedicated processor capability can be present to generate a large volume of outgoing email. The payment facility 160 can be implemented using the one or more processing units 603.

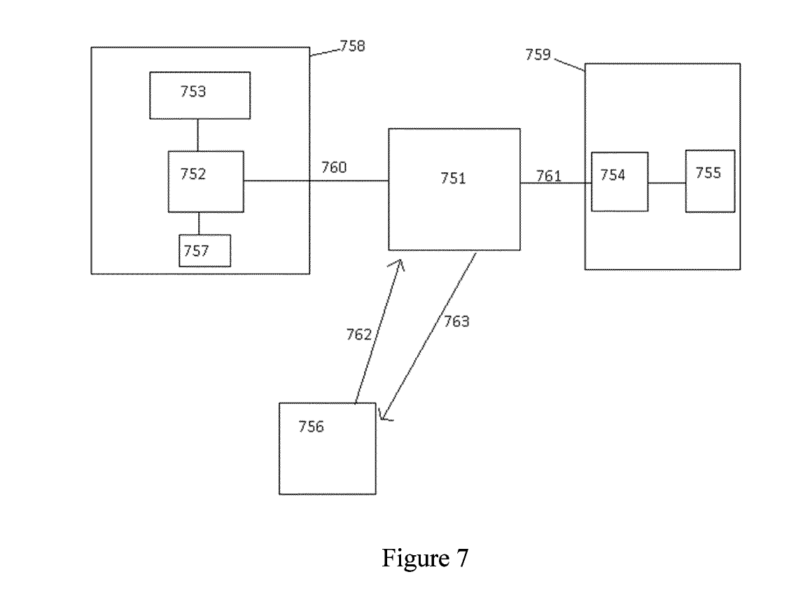

An overview of a system for providing biomarker test results is shown in FIG. 7. A control server 751 can connect 760 to a remote client 752. In some embodiments, the control server 751 can be on a separate server, virtual instance, intranet, or cloud than the remote client 752. In other embodiments, the control server 751 can be located on the same server, intranet, or cloud as the remote client 752. It is critical that the remote client 752 can be collocated on the same server, intranet, or cloud 758 as a genetic data storage server 753 to avoid requiring the transmission of large data genetic files to be transmitted over the internet and/or beyond a firewall. The genetic data storage server 753 contains the genetic, or other biological data of the patient. The control server 751 can also connect 761 to a genetic data interpretation server 755. The genetic data interpretation server 755 contains biomarker scripts that enable the interpretation of the genetic or other biological data stored on the genetic data storage server 753. In some embodiments, a listener 754 can be optionally used to create dedicated server processes with the genetic data interpretation server 755. The listener 754 and genetic data interpretation server 755 can be optionally collocated on the same server, intranet, or cloud as the control server 751, or they may be located on a separate server, intranet, or cloud from the control server 751.

A request for a genetic test, or other biological test, can be made 762 to the control server 751 by a health care provider or other user 756. In some embodiments a request can be made through a patient's electronic health records or electronic medical records. In some embodiments, a request can be made directly to the remote client 752 through a third party request application 757. The request can be transmitted to the control server 751. The control server can obtain the required biomarker script from the genetic data interpretation server 755 and transmit the biomarker script to the remote client 752. The remote client can execute the biomarker script on the data stored in the genetic data storage server 753. The results of the biomarker script can be sent back to the control server 751, which can transmit the results 763 to the user 756.

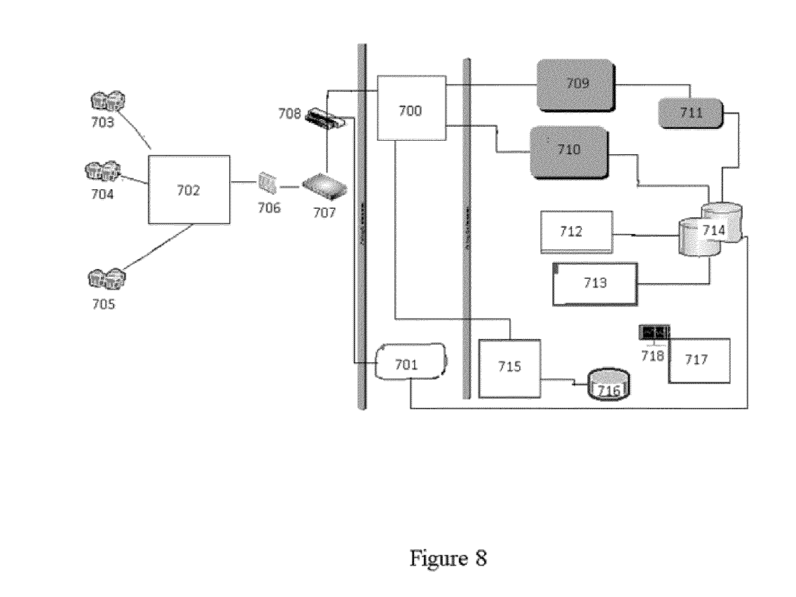

The query system of the present invention according to one embodiment is described in FIG. 8. The users of the system, such as hospitals 703, research laboratories 704, government agencies 705, or any other authorized user, can access the YouGene portal 700 positioned on an opposite side of a firewall 706. In some embodiments, the requests for test can come directly from the patient's electronic health records or electronic medical records. In other embodiments, the request for a test can come through a health information exchange. The users can access the portal through, for example, the internet 702 using a web browser such as Firefox, Internet Explorer or any other web browser. Communication between users and the portal can be established using SSL, HTTP, HTTPS, SOAP, or any other method known to those of ordinary skill in the art. Users can be authenticated and authorized through services authentication manager 715 LDAP 716 or any other authentication mechanism. The signal can be routed through load balancer 707 and switch 708 to reach the portal 700. Once the user logs in, the user will access to information based on the type of user according to a set of business rules 709. The ability to access information can be governed through content manager 710.

A query of genetic or other information can be sent through the application server 711 to databases 714. In some embodiments, the databases 714 can be owned and operated by a private company. In other embodiments the databases 714 can be owned and operated by third parties. Search engine 712 can query the databases according to the request. Reporting engine 713 can compile the results from the query. The results can be transferred to the user through file transfer system 701. The security and effectiveness of the entire system can be monitored by monitoring system 717 and administrative console 718. The communications between servers can be established by any means known in the art, including TCP/IP. Communication with the database can be established through any means known in the art, including JDBC.

The system described herein has efficiency based on data aggregation, consistent/unified UI, standardized security such as authentication and authorization, and security enforcement of roles based on access control. In some embodiments, it can also offer standardized business events notifications when new or updated or relevant information becomes available.

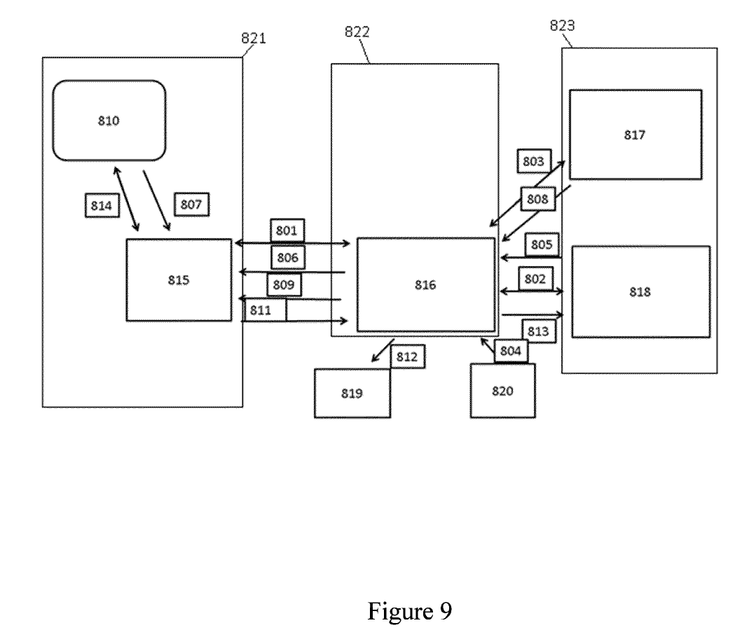

The modules and functions of the system are represented in FIG. 9. The control server (CS) 816 can be hosted on the web, cloud, server or any other location. The CS 816 is capable of exchanging information between one or more databases located on the same or different servers.

In one embodiment, a remote client application (RCA) 815 owned by a first company can also be a web, cloud, intranet or server hosted application. The RCA 815 can be affiliated with the CS 816. Multiple RCA's can exist on the same or separate cloud, intranet, or server. In some embodiments, the RCA 815 can be a temporary application on the remote cloud, intranet or server. In other embodiments, the RCA 815 can be permanent.

The genetic data storage server (GDSS) 810 can be a web, cloud, intranet or server data repository owned and, optionally operated by a second company behind a firewall. In some embodiments, the GDSS 810 can be operated and maintained by the first company. In other embodiments, the GDSS 810 can be operated by a third party, e.g. second company. The GDSS 810 can contain one or more digital test records. In some embodiments, the digital test records can comprise genetic test records. In other embodiments the digital test records can comprise other biological test data, such as protein or enzyme information. The GDSS 810 can communicate with the collocated RCA 815, responding to requests from RCA 815 and providing test results. Critically, GDSS 810 is on the same server, virtual instance, intranet, behind the same firewall, or in the same cloud environment 821, as RCA 815. This eliminates the need to send the sensitive, and very large, digital test results across the internet. In some embodiments the RCA 815 can be embedded as part of the GDSS 810. In other embodiments, the RCA 815 can operate outside of the GDSS 810, so long as the RCA 815 is collocated with GDSS 810.

One example of a genetic data storage server (GDSS) is the Illumina® Sequencing and Array Based Solutions system, e.g. BaseSpace. Other genetic data storage servers presently known can include Curoverse, GA Biobank, or any other known biorepository. The GDSS system typically offers the sequencing and storage of genetic data. However, any storage system, biobank, data repository, biorepository, or data commons capable of storing genetic data either in WGS, WES or any other known suitable output is contemplated by this invention. In some embodiments, the genetic data storage server can be any HIPAA compliant server capable of storing genetic data.

The genetic data interpretations server (GDIS) 817 can be a web, cloud, virtual instance, intranet, or server based data repository. The GDIS 817 can be operated by the first company or by a third party. The GDIS 817 can contain one or more biomarker scripts, with clinical interpretations based on results generated for the biomarker scripts.

The digital patient information storage server (PISS) 818 can be a web, cloud, intranet, or server hosted data repository. In some embodiments, the PISS 818 can be operated by the first company. In other embodiments, the PISS 818 can be operated by a third party. The PISS 818 can contain one or more patient records. The PISS 818 can communicate with CS 816 and can operate to update, edit or delete patient information.

One or more listeners can be used on any of the data repositories in order to create dedicated server processes for each user, and thereby increase efficiency and decrease memory constraints. In some embodiments, the data can be communicated using JSON or other communication protocol.

The CS 816 can be hosted in a separate cloud environment, intranet, or server 822 as RCA 815. However, in some embodiments, CS 816 can be in the same cloud environment, intranet, or server as RCA 815. In some embodiments, CS 816 and RCA 815 can be located on a single intranet. GDIS 817 and PISS 818 are shown in FIG. 9 as being in a single cloud, intranet, or server 823. In other embodiments, GDIS 817 and PISS 818 can be in separate clouds or servers. In some embodiments, GDIS 817 and PISS 818 can be in the same cloud, server or intranet as CS 816.

After all the software is installed, a communications portal 801 can be established between the CS 816 and the RCA 815. A second communications portal 802 can be established between the CS 816 and PISS 818. A third communications portal 803 can be established between the CS 816 and GDIS 817. A fourth communications portal 814 can be established between the RCA 815 and GDSS 810. The Communication portals 801, 802, 803 and 814 can be established and maintained via any combination of TCP, UDP, VPN, sockets, OS messaging or equivalent technologies suitable to transmit secure and unsecure information between two collocated or non-collocated software instances.

In any embodiment, a library, DLL, extension or API can be written into the genetic data storage server (GDSS) such as an operator, e.g. Illumina Basespace or any local hosting server, that can be incorporated into the GDSS owner's software that would allow the GDSS owner to run scans within their module by incorporating an outside code. In this manner, a GDSS can remain isolated and protected yet receive instructions via the Remote Client described herein. In particular, the embedded software, DLL or API can operate as the Remote Client, communicating with the Control Server, but embedded within another application.

For example, a prescription to test a biomarker 804 can be obtained by the CS 816 from a patient's electronic health records or electronic medical records, or from a health care provider 820. In some embodiments, health services providers can generate prescriptions directly through electronic health records and the prescription can be directly sent to the CS 816. Non-limiting examples of services for generating prescriptions directly through electronic medical records include Allscripts® or Surescripts®. However, any electronic prescription service is contemplated by this invention. In other embodiments, the prescription 804 can be transmitted to CS 816 by the health services provider through a user interface (not shown).

In any embodiment, an environment can be provided that runs open source and/or commercial tools (e.g. Galaxy, GATK, etc.). The environment can provide for deep provenance and reproducibility across all connections and provide a means to flexibly organize data and ensure data integrity. In any embodiment, the invention contemplates means for running distributed batch processing jobs that provide for secure sharing of data sets. The invention also contemplates providing a set of common APIs that enable application and pipeline portability across systems. The invention can be platform and system agnostic. In each instance, the invention can handle storing and organizing large data sets (e.g. BAM, FASTQ, VCF, etc.) and handle storing metadata about files for a wide variety of organizational schema. The invention further provides for an environment where stakeholders such as the genetic data storer, the prescriber, or control application owner can receive access to virtual machines (VMs) on a private or public cloud thereby eliminating the need to manage separate physical servers. In any embodiment, any of the services described herein including prescription, connections and scripts can be accessed through APIs.

For example, the prescription 804 can be communicated to CS 816. Digital test identification information 805 can be retrieved from the PISS 818 and communicated to the CS 816. The digital test identification information can comprise information necessary for locating one or more digital test records from GDSS 810. The digital test identification information can be sent 806 to RCA 815 for the purpose of locating one or more digital test records from GDSS 810. The digital test records can be retrieved and sent back 807 to the RCA 815. The digital biomarker script can be retrieved 808 from the GDIS 817 and sent to CS 816. The CS 816 can send the digital biomarker script 809 to the RCA 815. The script can be responsible for providing instructions to the RCA 815 necessary for the interpretation of the genetic or other biological data in accordance with the biomarker test prescription 804.

In any embodiment, the biomarker test prescription 804 can comprise any one or more of a biomarker identifier, a patient identifier, a physician identifier, a payer identifier, a test data identifier, and a test data location identifier where one or multiple GDSSs and RCAs are used as described herein.

The RCA 815 can execute the instructions in the biomarker script, operating on the digital test record. The results of the script can be returned 811 to the CS 816. The results of the script can be communicated 812 to the prescriber 819. In some embodiments, the results can be communicated 812 electronically. In other embodiments, the results can be communicated 812 to the prescriber 819 via any possible means of communication. The results of the script can also be archived 813 on the PISS 818.

In this way, a patient's genetic information can be queried, analyzed, and the results transmitted, without the need for transmitting the patient's actual genome across the internet. In other embodiments, PISS 818 is unnecessary. The specific patient information can be obtained directly from the prescriber 820 and transmitted to CS 816.

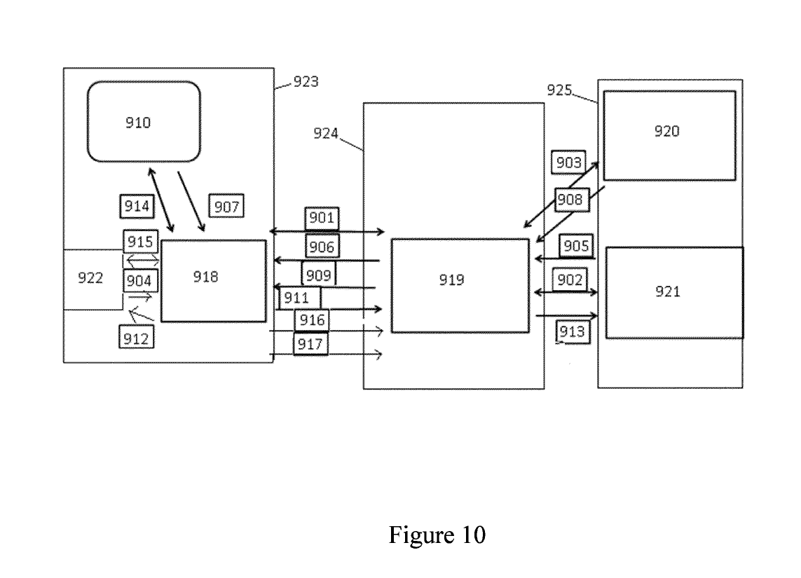

In an alternative embodiment, shown in FIG. 10, a request for a test result can be made directly by a third party requester through third party request application 922 from the same server, virtual instance, intranet, or cloud 923 as the RCA 918. The third party requester can directly connect to the RCA 918. Such an embodiment allows a request and the results from the testing to be executed and returned without the need to send the information across the internet. In any embodiment, the third party request application 922 and the RCA 918 can be collocated. A communications portal 915 can be established between third party request application 922 and RCA 918. A communications portal 914 can be established between the RCA 918 and GDSS 910, communications portal 901 can be established between RCA 918 and CS 919, communications portal 903 can be established between CS 919 and GDIS 920, and communications portal 902 can optionally be established between CS 919 and PISS 921. In operation, the system works similar to the system in FIG. 9. A request for test results 904 is transmitted from the third party request application 922 to the RCA 918. In some embodiments, the third party request application can be embedded in the GDSS 910 as described herein. RCA 918 communicates a request for patient information 916 to CS 919. The digital test identification information 905 corresponding to the request can be retrieved from the PISS 921 and communicated to the CS 919. The digital test identification information can be sent 906 to RCA 918 for the purpose of locating one or more digital test records from GDSS 910. The digital test records can be retrieved and sent back 907 to the RCA 918. A request for a digital biomarker script 917 can be sent from the RCA 918 to the CS 919. The digital biomarker script can be retrieved 908 from the GDIS 920 and sent to CS 919. The CS 919 can send the digital biomarker script 909 to the RCA 918. The script can be responsible for providing instructions to the RCA 918.

The RCA 918 can execute the instructions in the biomarker script, operating on the digital test record. The results of the script can be returned 911 to the CS 919, and the results can be sent 912 to the third party request application 922. In some embodiments, the results of the script can also be archived 913 on the PISS 921.

Critically, RCA 918 can be located on the same server, virtual instance, intranet, or in the same cloud 923 as GDSS 910. CS 919 may be located on a separate server, virtual instance, intranet, or cloud 924 from the RCA 918. GDIS 920 and PISS 921 are shown on a single server, intranet or cloud 925. In some embodiments, GDIS 920 and PISS 921 can be on separate servers, intranets or clouds. In other embodiments, one or both of GDIS 920 and PISS 921 can be located on the same cloud, virtual instance, intranet or server 924 as the CS 919.

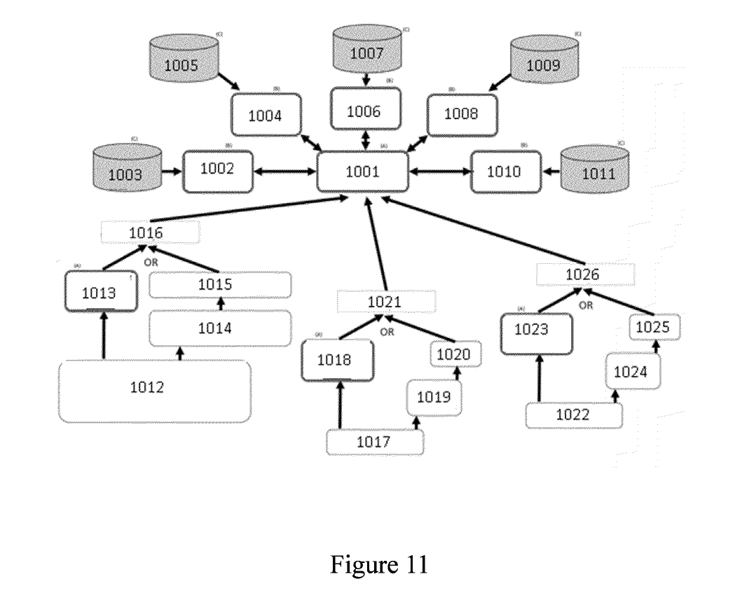

The system is not limited to one source of prescriptions, or one digital test database. Multiple databases and request sources can be accommodated as shown in FIG. 11. CS 1001 can communicate with a first RCA 1002 collocated with a first GDSS 1003, a second RCA 1004 collocated with a second GDSS 1005, a third RCA 1006 collocated with a third GDSS 1007, a fourth RCA 1008 collocated with a fourth GDSS 1009 and a fifth RCA 1010 collocated with a fifth GDSS 1011. Any number of RCAs each corresponding to a separate GDSS is contemplated by this invention.

Similarly, CS 1001 can receive prescriptions from multiple sources. First provider or requester 1012 can provide a biomarker test prescription 1016 either through a subject-host machine interface 1013, or through electronic medical records or electronic health records 1014 which can communicate the biomarker test prescription 1016 through interface application 1015. Second provider or requester 1017 can provide a biomarker test prescription 1021 either through a subject-host machine interface 1018, or through electronic medical records or electronic health records 1019 which can communicate the biomarker test prescription 1021 through interface application 1020. Third provider or requester 1022 can provide a biomarker test prescription 1026 either through a subject-host machine interface 1023, or through electronic medical records or electronic health records 1024 which can communicate the biomarker test prescription 1026 through interface application 1025. Again, any number of providers or requesters is contemplated by this invention. In embodiments, as shown in FIG. 11, the biomarker test prescription can include a test data location identifier, which can point to the particular RCA and GDSS for the CS to communicate.

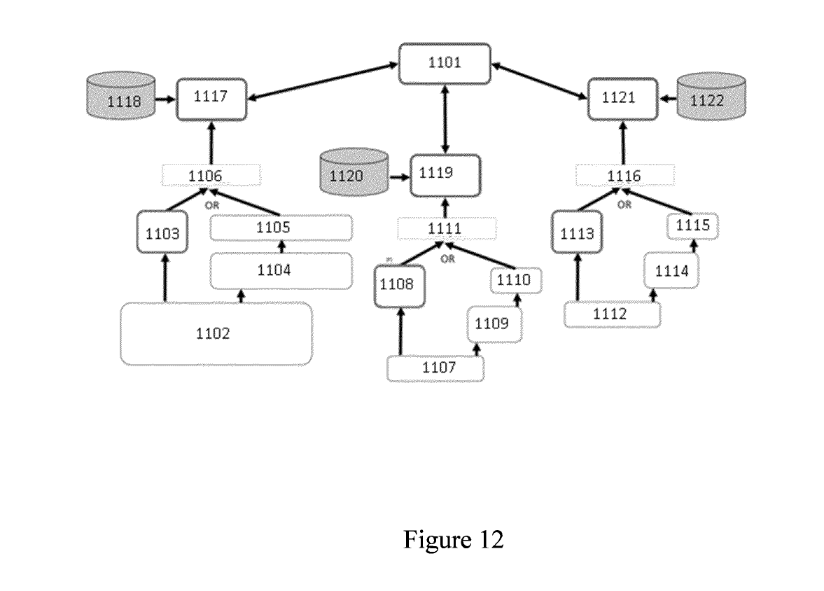

As shown in FIG. 12, in embodiments where a third party request is initiated from the same server, intranet, or cloud as the RCA the system is not limited to a single GDSS and RCA. CS 1101 can communicate with first RCA 1117 collocated with first GDSS 1118, second RCA 1119 collocated with second GDSS 1120, and third RCA 1121 collocated with third GDSS 1122. Any number of RCAs each collocated with a GDSS is contemplated by this invention. A first provider or requester 1102 can initiate a test with a third party request application 1103 or through electronic health records or electronic medical records 1104, which can act through interface application 1105. The biomarker test prescription 1106 can be directly communicated to the first RCA 1117. RCA 1117 can communicate with CS 1101 and GDSS 1118 as explained above to carry out the test and reporting procedure. A second provider or requester 1107 can initiate a test with a third party request application 1108 or through electronic health records or electronic medical records 1109, which can act through interface application 1110. The biomarker test prescription 1111 can be directly communicated to the second RCA 1119, which can communicate with collocated GDSS 1120 and CS 1101 to carry out the biomarker test. A third provider or requester 1112 can initiate a test with a third party request application 1113 or through electronic health records or electronic medical records 1114, which can act through interface application 1115. The biomarker test prescription 1116 can be directly communicated to the third RCA 1121, which can communicate with collocated GDSS 1122 and CS 1101 to carry out the biomarker test.

It will be understood that any number of providers or requesters can initiate a test through a single RCA. It will also be understood that any number of RCAs each collocated with a GDSS is contemplated by this invention.

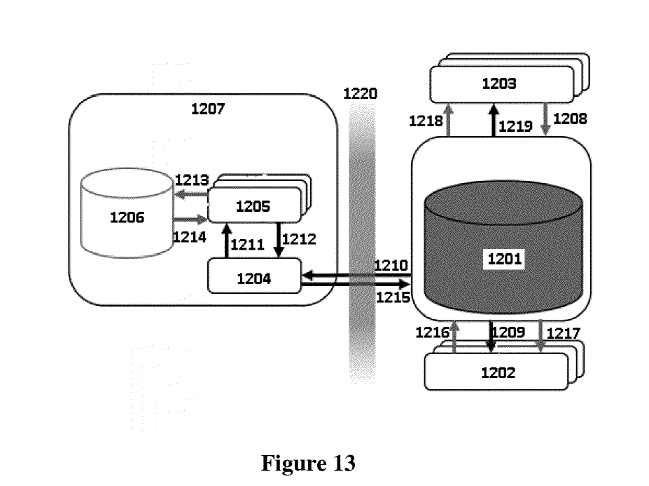

In any embodiment, the genetic scanning functions described herein can be combined with the proprietary biomarker functions. One embodiment of the implementation of the combined system is shown in FIG. 13. A third party requester can initiate and carry out the genetic testing, while the control server of the present invention can act to facilitate the transfer of proprietary biomarker rights. A third party requester 1205 can initiate a genetic test from GDSS 1206. In order to ensure that licenses for proprietary biomarkers or test information are properly obtained, a third party scan application 1205 can transmit the genetic usage data 1212 to a remote application 1204. The genetic usage data can comprise information concerning the tests to be run and the biomarkers to be searched. The remote application 1204 can transmit this genetic usage data 1215 to the control server 1201. The control server 1201 can contain information concerning the ownership and licensing agreements of proprietary biomarker or test information. The control server 1201 can send the genetic usage information to the proprietary biomarker or test owners 1202. As explained herein, for a given genetic test, more than one right holder may be implicated. As such, the control server 1201 can transmit the genetic usage information to any and all rights holders 1202. This is shown as three different parties in FIG. 13, however it will be understood that any number of parties can hold rights implicated by any test. The rights holders 1202 can transfer licenses 1216 to the owner of the control server 1201. The control server 1201 can transmit the genetic usage information 1219 back to the third party 1203 for payment. In FIG. 13, the third party scan application 1205 is owned by a third party, and not the owner of the control system. The licenses obtained by the rights holders can also be transferred 1218 to the third party 1203 as discussed herein. The third party 1203 can make the licensing fee payments 1208 to the owner of the control server 1201. The control server 1201 can also transfer royalty payments 1217 to the rights holders 1202. As explained herein, the scanning applications can be collocated with the GDSS 1206 on cloud or server 1207. To protect privacy, the GDSS 1206 and collocated applications can be protected behind firewall 1220. The modules described in FIG. 13 allow for the accounting and transfer of proprietary rights necessary for genetic testing and payment for those rights by a centralized control system.

It will be understood that the timing or order of the steps described in FIG. 13 can be varied. For example, it may not be necessary to obtain a license for a proprietary test unless the test shows a positive result. As such, the royalty payment 1217, licensing fee 1208, and licensing transactions 1216 and 1218 can occur after all of the scanning of genetic information. In other embodiments, the transmission of the results 1219 can be delayed until after the license fee has been paid 1208.

In some embodiments, the control server 1201 can act as a licensing warehouse as explained herein. The control server 1201 can obtain licenses for proprietary genetic testing from various genetic IP owners 1202. The control server 1201 can then transfer those licenses to third party test requesters 1203 as necessary. The licenses can be obtained independently of requests for genetic tests, or can be obtained each time a particular proprietary test is requested. In some embodiments, the control server 1201 can periodically or continuously search databases, indexes, catalogs, and in various languages, for patented or proprietary genetic biomarkers and related information as discussed herein. Licenses for the use of these biomarkers or tests can be obtained whether or not a request has been made.

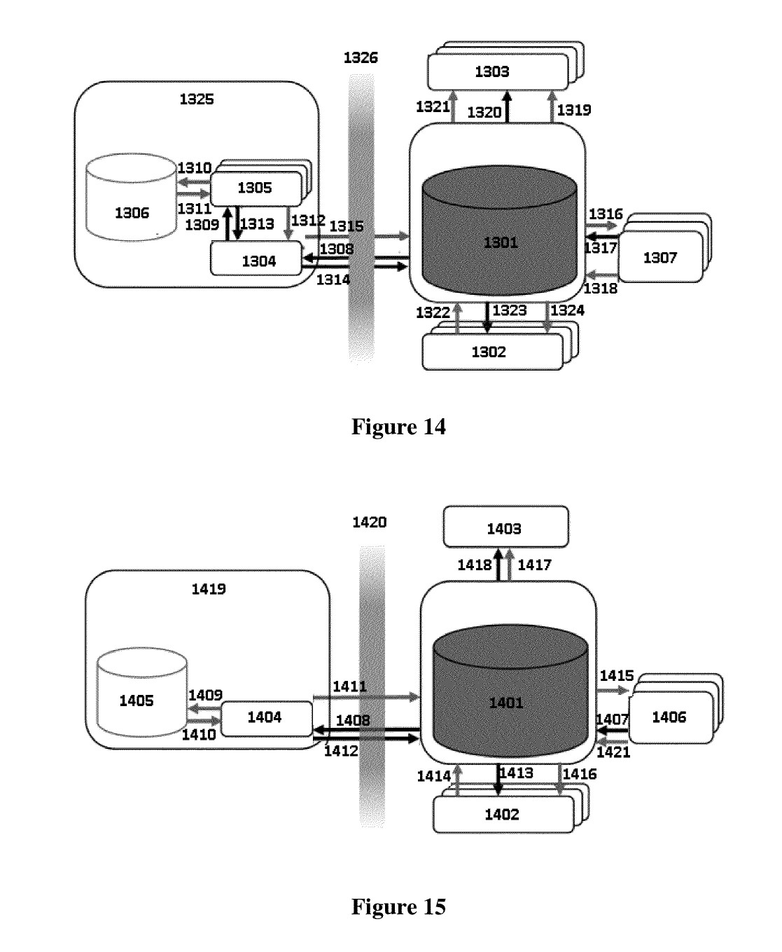

A different embodiment is shown in FIG. 14. The request for a genetic test can be initiated by the control system 1301. This request can come from an outside source 1307, including requests from electronic health records or electronic medical records. The requestor 1307 can send the genetic test request 1317 to the control server 1301. The control server 1301 can transmit this request to remote application 1304. In some embodiments, the testing can be carried out by third party scan application 1305. In such embodiments, the remote application 1304 can transmit the genetic request 1309 to the third party scan application 1305. The third party scan application 1305 can make a request 1310 to GDSS 1306 for the particular patient's genetic information. The GDSS can transmit the genetic data 1311 back to the third party scan application 1305 where the scan can be conducted. The results of the scan can be transmitted back 1312 to remote application 1304, as well as the genetic usage data 1313 necessary for coordinating licensing agreements. The remote application 1304 can transmit the genetic usage information 1314, as well as transmit the results of the testing 1315 back to control server 1301. The results of the test can be sent 1316 to the original requester 1307. Similar to the embodiment shown in FIG. 13, control server 1301 of FIG. 14 can determine the rights holders 1302 of proprietary biomarkers or tests and transmit the information concerning the test 1323 to the rights holders 1302. Licenses can be obtained 1322 from the rights holders, and transferred 1321 to the third party 1303 that carried out the genetic testing, along with the genetic usage information 1320 concerning the tests carried out. In FIG. 14, the third party scan application 1305 is owned by a third party, and not the owner of the control system. The requestor, or a separate payer party, can make a payment 1318 to the control server 1301. This payment can include the costs of testing, which can be transferred 1319 to the third party 1303 that carried out the test. The payment from the requester can also include licensing fees, which can be paid as royalties 1324 by the control server 1301 to the rights holders 1302. As discussed herein, to protect privacy, the scanning application 1305 can be collocated on a cloud or server 1325 with the GDSS 1306 behind a firewall or other security 1326. In some embodiments, all of the payment, licensing and other functions of the system can occur on the opposite side of the firewall 1326.

As discussed herein, the order of the events shown in FIG. 14 can be varied. For example, the payment of licensing fees and royalties may occur before the genetic testing. In some embodiments, the control server can obtain licenses for proprietary genetic tests or biomarkers before any requests are made that implicate the proprietary information. In some embodiments the payment from the requestor can be made in separate transactions, such as a payment covering the licensing fees first, and payment for the genetic testing second. It will be understood that some of the steps shown can be omitted. For example, the genetic testing fee can be negotiated and accounted for between the requestor and third party directly, without the use of the control server.

As discussed herein, the genetic scanning need not be carried out by a third party. As shown in FIG. 15, a remote application 1404 in communication with control server 1401 can carry out the genetic testing directly, without a third party scanning application. A requester 1406 can transmit the request for a genetic test 1407 to control server 1401. The control server can be collocated with GDSS 1405 on a cloud or server 1419 behind firewall 1420. The control server can transmit the request 1408 to remote application 1404. The remote application can make a request for a patient's genetic data 1409 to GDSS 1405. The GDSS can transmit the genetic information 1410 back to the remote application 1404 for scanning. After scanning the data, the results of the test can be sent 1411 to control server 1401. The genetic usage information 1412 can also be sent to control server 1401. The control server 1401 can transmit the genetic usage data 1413 to the rights holders 1402 of proprietary biomarkers or tests that were used. Licenses for use of the proprietary information can be obtained 1414. The results of the genetic tests can be sent 1415 to the requester 1406. The requester or payer party 1406 can make a payment 1421 through control server 1401. This payment can include royalties which can be transferred 1416 to the rights holders 1402, and payment for use of the genetic data storage server, which can be transferred 1417 to the owner of the GDSS 1403. In the system described in FIG. 15, it will be understood that the GDSS 1403 is owned by a third party, and not the owner of the control server. Genetic usage information can also be sent 1418 to the owner of the GDSS 1403 if necessary to account for the costs.

In any embodiment, the systems described herein can be utilized with new or proprietary testing or sequencing technology. One example is the blood testing platform of Theranos, Inc., which allows for blood testing with a very small amount of blood. In some embodiments, a company, such as Theranos, can obtain blood samples from patients, sequence the genome, and place the genetic sequence in a genetic data storage server in any of the modules herein described. The company can then order testing of the patient's genetic sequence using proprietary biomarkers, utilizing the current invention to account for licenses and royalties relating to the proprietary biomarkers. In other embodiments, the company can have the genome sequenced by a third party and placed in the modules herein described, and then the company can order the necessary genetic tests using proprietary biomarkers. The speed and efficiency of the scanning process using the current invention, along with the ability to account for the use of proprietary biomarkers, allows a company to offer a wide range of genetic tests from a small sample of blood.

In some embodiments, the system can be configured to determine new biomarkers for a genetic disease. Because several of the genetic tests may be run multiple times, the system can automatically determine if a new biomarker exists. For example, the system can be configured to automatically start searching for a new biomarker for a particular disease associated with a known biomarker whenever the number of tests for the known biomarker exceeds a pre-set number. In some embodiments, the pre-set number can be 500. In other embodiments, the pre-set number of tests for a given biomarker can be between any of 200-500, 400-600, 500-1000 or more, before the system can automatically start to search for new biomarkers.

The genetic data of many patients can be saved into the system as explained above. The genetic tests run on each of the patients, along with the results of the test, can also be saved. Using the results, and the genetic data saved into the system, a search for a new biomarker becomes possible.

For example, in one non-limiting embodiment, once 500 tests for a particular biomarker associated with a particular disease are run, the system can search for a new biomarker for the same disease. The system can separate the patients that have been tested for the disease into a subgroup, and search only those patients that have been tested for the particular biomarker, as these patients are known candidates for the disease.

By searching only the subgroup of patients that have been tested for a particular biomarker associated with a disease, the search becomes significantly faster and more reliable. Without breaking the population into particular subgroups, there would be so many possible associations that the system would return false positives. To prevent the return of false positives, a very low p-value as demanded by the Bonferonni Criteria would be required, which may be impossible to achieve. By using only the subgroup that has been tested for a particular disease, the demands are relaxed. For example, if there are 100 diseases being tested, a p-value can be 100 times larger using subgroups than without using the subgroups.

In some embodiments, the test for a new biomarker can be repeated each time a new test for a particular disease is ordered. This can be done to ensure the reliability of a biomarker found in the initial search, or to continue the search for a new biomarker. Because each new test creates a larger subgroup of patients for searching, the search for a new biomarker becomes more reliable.

Without the system described herein, each time a new test is ordered, and the biomarker search repeated, every new patient will have to be compared to every patient in the subgroup. If 50 new tests are ordered for a particular biomarker or disease, and there were 500 previous tests for the same biomarker or disease, 50 new correspondence tests would need to be run, each with over 500 patients having millions of nucleotides in their genetic sequence. The testing would be prohibitively arduous. However, the system can be configured to determine the base pair that exists at each genetic location for each patient, determining the number of A bases, C bases, T bases and G bases for each location. When a new test is ordered, the system can determine the new patient's base pair at each location and add this base pair to the appropriate tally. Only one of the counts for each location needs to be updated for each new test. The updated tallies can then be used in determining a correlation to a possible new biomarker. By tallying the base pairs in this manner, the system can increase the speed of the search for new biomarkers by a factor equal to the total number of patients for whom a test has been ordered. For example, if 500 patients have been tested for a particular disease, the search for a new biomarker can be 500 times faster using the system described herein. Instead of each correlation test being run for each of the 500 patients, only one test needs to be run using the tallies at each location.

In any embodiment, each of the functions for determining a new biomarker can take place in any module of the system. For example, the control server can create and update the list of patients for each subgroup that has been tested for a particular biomarker or disease; the genetic data storage server can keep and update the tally of the number of base pairs at each location for each subgroup, and the remote application can determine the correlation between a new biomarker and a disease. In other embodiments, the control server, remote application, or genetic data storage server can conduct each of the tasks described. The location of each of the tasks is not critical to the invention.

The software implementing the above processes can be coded in any language known in the art. This includes, but is not limited to, ASP, APS.NET, Java, JavaScript, C, C++, C#, C#.NET, Objective C, F#, F#.NET, Basic, Visual Basic, VB.NET, Go, Python, Perl, Hack, PHP, Erlang, XHP, Scala, Ruby, J2EE, SQL, CGI, HTTP, or XML.

It will be apparent to one skilled in the art that various combinations and/or modifications and variations can be made in the system depending upon the specific needs for operation. Moreover features illustrated or described as being part of one embodiment may be used on another embodiment to yield a still further embodiment.

We claim:

1. A system, comprising:
a control server connected to a remote application, the remote application configured to obtain results of a genetic test;
a proprietary records database connected to the control server, the proprietary records database containing records of proprietary biomarkers and rights holders of the proprietary biomarker; and
a genetic data storage server in communication with the remote application, the genetic data storage server containing genetic information of one or more patients;
wherein the remote application is configured to send and receive data for conducting the genetic test; and
wherein the control server is configured to send and receive data for accounting for payment from a payer party to the rights holder.

2. The system of claim 1 wherein the remote application is configured to receive genetic data from the genetic data storage server, and wherein the remote application is configured to carry out the genetic test.

3. The system of claim 2 wherein the control server is configured to account for a payment to the owner of the genetic data storage server for storage of the genetic data.

4. The system of claim 1 wherein the remote application is in communication with a scan application, the scan application configured to carry out the genetic test, and wherein the control server is configured to account for payment to the owner of the scan application based on the genetic test.

5. The system of claim 1 wherein the control server is configured to receive a request for a genetic test from a third party.

6. The system of claim 1 wherein the remote application is collocated with the genetic data storage server.

7. The system of claim 1, wherein the control system is configured to determine a genetic test requested for more than one patient; and
wherein the control system is configured to create a subgroup of patients, wherein the subgroup of patients are patients for which the same genetic test is requested.

8. The system of claim 7, wherein either the genetic data storage server or the remote application is configured to determine an association between the genetic information at a particular genetic location for the more than one patients and a genetic disease.

9. The system of claim 8 wherein either the genetic data storage server or the remote application is configured to create a tally of base pairs for each of the more than one patients at one or more genetic locations; wherein the tally comprises the number of patients with each of the base pairs at the at least one genetic location.

10. The system of claim 9 wherein the system is configured to update the tally of base pairs with the base pairs for a new patient each time a new test is ordered for the genetic disease.

11. The system of claim 10 wherein either the genetic data storage server or the remote application is configured to determine an association between the genetic information at each of the one or more genetic locations for the more than one patients and a genetic disease each time a new test is ordered for the genetic disease.

12. A system, comprising:
a control server connected to a remote application, the remote application configured to obtain genetic usage data from a payer and to transmit the genetic usage data to the control server;
the control server in communication with a proprietary records database, the proprietary records database containing records of proprietary biomarkers and rights holders of the proprietary biomarker;
wherein the control server is configured to account for a payment from a payer party to the rights holders based on the genetic usage data.

13. A method, comprising the steps of:
obtaining genetic usage information from a payer party, wherein the genetic usage information comprises one or more of a prescription for a genetic test, the biomarkers to be searched during a genetic test, and/or the portions of the genome to be scanned during a genetic test;
accessing a proprietary records database, the proprietary records database containing records of proprietary biomarkers and the rights holders of proprietary biomarkers;
determining the proprietary biomarkers necessary to conduct a genetic test based on the genetic usage information; and
accounting for a payment from the payer party to the rights holders of the proprietary biomarkers from the payer party based on the genetic usage information.

14. The method of claim 13, further comprising the step of obtaining genetic information for a patient from a genetic data storage server;
scanning the genetic data to obtain a test result based on the genetic usage information; and
transmitting the test result to the payer party.

15. The method of claim 13, further comprising the steps of:
transmitting the genetic usage information to a scanning application, the scanning application configured to obtain genetic information for a patient and conduct a genetic test;
obtaining the results of the genetic test from the scanning application;
obtaining a license for use of the proprietary biomarker from the rights holder of the proprietary biomarker;
transferring the license for use of the proprietary biomarker to the owner of the scanning application; and
accounting for a payment from the payer party to the owner of the scanning application.

16. The method of claim 14 wherein the step of scanning the genetic data is conducted by a remote application, and wherein the remote application is collocated with the genetic data storage server.

17. The method of claim 13, further comprising:
obtaining prescriptions for genetic tests on more than one patient;
obtaining genetic information for each of the more than one patients from a genetic data storage server;
scanning the genetic information for each of the more than one patients in order to obtain more than one genetic test result;
separating the genetic information for each of the more than one patients from all other genetic information on the genetic data storage server;
comparing the genetic information for each of the one or more patients; and
determining a correlation at one or more locations in the genetic sequences of the more than one patients to the more than one result.

18. The method of claim 17, further comprising:
determining the base pair present at one or more genetic locations for each of the more than one patients;
creating a tally of the number of each type of base pair at each of the one or more genetic locations for the more than one patients.

19. The method of claim 18, wherein the step of determining a correlation comprises utilizing the tally of the number of each type of base pair at each of the one or more genetic locations.

20. The method of claim 19, further comprising:
obtaining a prescription for a genetic test for at least one additional patient;
determining the base pair present at the one or more genetic locations for the at least one additional patient;
increasing the tally corresponding to the base pair at each of thee one or more genetic locations based on the genetic data of the at least one additional patient; and
determining a correlation at one or more locations in the genetic sequences of the more than one patients to the more than one result utilizing the tally of the number of each type of base pair at each of the one or more genetic locations.
